(19) United States
(12) Patent Application Publication
(10) Pub. No.: US 2004/0184876 A1
(43) Pub. Date: Sep. 23, 2004

(54) Coupling for coupling two devices and method for using the coupling

(76) Inventors: Lasse L. Hessel, Svendborg (DK); Jesper Malling, Svendborg (DK); Robert Axelsson, Granna (SE)

Correspondence Address: WINSTON & STRAWN, PATENT DEPARTMENT, 1400 L STREET, N.W., WASHINGTON, DC, 20005-3502, US

(21) Appl. No.: 10/773,697

(22) Filed: Feb. 6, 2004

Related U.S. Application Data
(63) Continuation of application No. PCT/DK02/00197, filed on Mar. 23, 2002.

(30) Foreign Application Priority Data
Aug. 8, 2001 (WO) PCT/DK01/00529

(51) Int. Cl. B25G 3/18

(52) U.S. Cl. 403/326

(57) ABSTRACT

The coupling serving for detachably coupling first and second devices. The coupling includes a first coupling part on the first device and a second coupling part on the second device. The first coupling part is designed with a circumferential coupling groove defined by a radial interior wall and exterior wall respectively and ending in a free end face facing in the opposite direction of the first device. The second coupling part includes first and second discs each designed with an aperture. First and second coupling collars respectively are provided around the apertures of the first and second discs and extend mainly in cross direction of the respective discs. The second coupling collar extends through the aperture in the first disc in the same direction as the coupling collar of this disc whereas the two coupling collars of the second coupling part extend into and engage the circumferential coupling groove of the first coupling part in the coupled state of the devices. The coupling has a simple design and is quick and easy to operate. It is well suited for detachably connecting a stoma of a stomy-operated person with an ostomy pouch.

### CROSS-REFERENCE TO RELATED APPLICATIONS

This application is a continuation of International application PCT/DK02/00197 filed Mar. 23, 2002, the entire content of which is expressly incorporated herein by reference thereto.

### BACKGROUND ART

The invention relates to a coupling for detachably coupling first and second devices and comprising a first coupling part on the first device and a second coupling part on the second device.

Detachable couplings are known and used for coupling many different kinds of devices such as pneumatic and hydraulic devices, but they are also used to a great extent for hospital equipment and personal aids. For example, detachable couplings are used for detachably coupling the stoma of a stomy-operated person to an ostomy pouch which frequently has to be changed for a new pouch. With a view to the comfort and hygiene of the stomy-operated person, the change must be done in a quick, safe and simple manner.

Conventional ostomy pouches are equipped with an adhesive ostomy wafer for being adhered on the skin around the stoma. Gradually, the skin will however have a tendency to become sensitive and irritated upon repeated use of such adhesive ostomy wafers, the result of which is that the adhesive ostomy wafer will not be fixed firmly enough around the stoma and therefore no longer be able to produce the required safety against leakage from the stoma. Furthermore, great or small projections and unevennesses are formed at the construction of a stoma and they can in themselves constitute a considerable obstacle to obtain a safe and effective adhesion of skin and adhesive ostomy pouch.

With a view to avoid the above disadvantages, adhesive ostomy wafers have therefore been developed with projecting coupling parts for detachable mounting of the ostomy pouch. U.S. Pat. No. 4,460,363 disclose such a coupling system for coupling an ostomy pouch detachably to an associated adhesive ostomy wafer. This known coupling system comprises two coupling members, of which one is an annular collar fitted at the edge of an aperture in the adhesive ostomy wafer. The collar can furthermore be arranged with a thin, elastic sealing lip. The corresponding annular coupling member projecting from the ostomy pouch has a radial interior wall and a radial exterior wall and is attached along the aperture of the ostomy pouch by means of hot welding. The last-mentioned coupling member has a radially U-shaped cross section, and a bead is made along the inner periphery of the exterior wall and it is engaging under the sealing lip when the two coupling parts are pressed together.

The coupling parts are forced out of their mutual engagement by both twisting and pulling at the coupling parts. Hereby, these parts are subjected to stresses and shear forces that can cause a weakening of the adhesion between the adhesive face and the skin area, and a penetration of secretions and excretions under the adhesive face. At the same time there is a risk that the coupling parts will be damaged in such a way that the sealing lip will not seal effectively when a new ostomy pouch is mounted.

To avoid use of adhesive ostomy wafers completely, some stomas are surgically made with an annular implant arranged around the stoma. By means of various associated couplings or coupling parts, the ostomy pouch is then detachably mounted on this implant. Such an implant is known from the present inventors' U.S. Pat. No. 6,017,355.

Two different couplings with associated ostomy pouches are furthermore known from the inventors' Danish patents nos. 173488 and 173652. These couplings are both arranged to be pressed together close-fittingly and effectively by means of a clamp around a device with a circumferential groove. These couplings are limited to use on devices with a corresponding circumferential groove such as e.g. the above-mentioned implant. Furthermore, both couplings are arranged with handles for opening the clamp when the two handles are pressed towards each other. These handles together with the clamp are preferably placed inside the pouch and will therefore be completely or partially surrounded by the excretions that are received in the pouch. To a certain extent, this fact contributes to making localization of the handles difficult, and a person can furthermore have difficulty in holding onto the handles due to the more or less solid or greasy body secretions or excretions surrounding the handles.

Accordingly, improvements in these type couplings are desired and they are now provided by the present invention.

### SUMMARY OF THE INVENTION

The present invention relates to a coupling that has a simple design and by means of which two devices can be detachably coupled quickly and easily.

The novel and unique features according to the invention, whereby this is achieved, is based on the use of a first coupling part on the first device and a second coupling part on the second device, with the first coupling part having a circumferential coupling groove defined by a radial interior and exterior walls respectively and ending in a free end face facing in the opposite direction of the first device, and the second coupling part including first and second discs each having an aperture. Also, first and second coupling collars are respectively designed around the apertures of the first and second discs and extend mainly in a cross direction of each respective disc. The second coupling collar extends through the aperture of the first disc in the same direction as the coupling collar of this disc, and the two coupling collars of the second coupling part extend into and engage the circumferential coupling groove of the first coupling part when the devices are coupled.

The two devices are coupled and uncoupled by merely guiding the two coupling collars of the second coupling part respectively into and out of the coupling groove of the first coupling part. These operations can be done quickly and easily as the discs have a relatively large supporting surface and a shape that makes them easy to locate and convenient to manipulate with the fingers.

A good, strong engagement between the first and second coupling part is obtained when the radial exterior wall at the coupling groove of the first coupling part is designed with a circumferential projection facing radially inwards and defining an offset onto which the second coupling part can hang at coupling.

The coupling according to the invention is well suited for detachably coupling the stoma of a stomy-operated person to an ostomy pouch. In this case, the first device can be a tubular implant implanted around a stoma of a stomy-operated person whereas the second device is the ostomy pouch.

The second coupling part can then be placed inside the ostomy pouch with the coupling collars extending out of the aperture of this pouch, an edge area around this aperture being attached on the first disc.

Where the free end face on the radial exterior wall of the first coupling part is abutting closely against an area of the first disc in the coupled state of the two devices, a tight connection is obtained that effectively secures against leakage of e.g. secretions or excretions from the stoma of the stomy-operated person.

In a preferred embodiment according to the invention, the first disc can have a first section extending radially outwards from its aperture in a direction mainly perpendicular to the axis of this aperture, and a conic second section extending radially outwards in continuation of the first section whereas the second disc is extending conically outwards from its aperture.

This expedient design of the second coupling part will result in the fact that a stomy-operated person using the coupling together with an implant around his stoma easily can get his fingers in between the body and the pouch and via this manipulate the second coupling part so that it will let go of the implant.

### BRIEF DESCRIPTION OF THE DRAWINGS

The invention will be explained in greater detail below, describing only exemplary embodiments with reference to the drawing, in which

FIG. 1 is a perspective view of a first coupling part in form of an annular implant for The coupling according to the invention,

FIG. 2 is a side view of a second embodiment of a first coupling part,

FIG. 3a is a perspective view of a first annular disc for a first embodiment of a second coupling part for The coupling,

FIG. 3b is a perspective view of a second annular disc for a second embodiment of a second coupling part for The coupling,

FIG. 4 is a sectional view taken along the line IV-IV of FIGS. 3a and 3b but with the second coupling part shown joined and mounted on a fragmentarily shown implant of FIG. 1,

FIG. 5a is on a larger scale a fractional, perspective view partly in section of the first coupling part in FIG. 1 and the second coupling part in FIGS. 3a,b during coupling,

FIG. 5b shows the same view as FIG. 5a but in coupled state,

FIG. 6 is a bottom perspective view of the implant in FIG. 1 coupled onto the second coupling part in FIGS. 3a,b,

FIG. 7 is a perspective view of the second coupling part in FIGS. 3a,b placed inside an ostomy pouch,

FIG. 8 is an exploded bottom perspective view of the implant in FIG. 1 and a second embodiment of a second coupling part for The coupling according to the invention with a first and second disc,

FIG. 9 shows the same view as FIG. 8 but with the two discs of the second coupling part hinged to each other and forming an angle with each other,

FIG. 10 shows the same view as FIG. 8 but with the implant joined with the first disc,

FIG. 11 shows the same view as FIG. 8 but with the second disc swung in under the first disc so that the implant is locked in the second coupling part,

FIG. 12 just as FIG. 8 shows the implant in FIG. 1 and the associated second coupling part but seen from above on a larger scale in an exploded perspective view,

FIG. 13 is a sectional view of the second coupling part in the opened position in FIG. 9,

FIG. 14 is a fractional view of the implant in FIG. I coupled to the second coupling part in FIGS. 8-12 in closed position,

FIG. 15 is on a larger scale a fractional sectional view of the coupling in FIG. 14 during coupling and with an ostomy pouch joined to the outer side of the first disc,

FIG. 16 shows the same view as FIG. 15 but in coupled state,

FIG. 17 shows a blank for a third embodiment of a second coupling part for The coupling according to the invention with an interconnected first and second disc,

FIG. 18 shows a plan view of the same seen from the first disc in a closed position of the second coupling,

FIG. 19 shows a plan view of the same seen from the second disc in a closed position of the second coupling,

FIG. 20 shows a perspective view of the third embodiment of the second coupling seen from a first embodiment of a lock means,

FIG. 21 shows a perspective view of the third embodiment of the second coupling seen from the hinge,

FIG. 22 shows a perspective view of a fourth embodiment of the second coupling seen provided with a second embodiment for a lock means,

FIG. 23 shows on a larger scale a fractional sectional view of the second embodiment for the lock means taken along the line XXIII-XXIII of FIG. 22,

FIG. 24 shows a perspective view of a fifth embodiment of the second coupling seen from a third embodiment for a lock means,

FIG. 25 shows a perspective view of a sixth embodiment of the second coupling seen from a fourth embodiment for a lock means, and

FIG. 26 shows on a larger scale a fractional sectional view of the fourth embodiment for the lock means taken along the line XXVI-XXVI of FIG. 25.

### DETAILED DESCRIPTION OF THE PREFERRED EMBODIMENTS

In a preferred embodiment of the invention, in the second coupling part, a number of evenly distributed windows can be designed in the first coupling collar, the second coupling collar can be designed with a number of elastic fingers extending completely or partly into each their window, the free end of each finger can be designed with a hook facing radially outwards, and the hooks can be abutting against the offset on the radial exterior wall in the coupling groove of the first coupling part in the coupled state of the two devices. Thereby, an especially strong, safe coupling is obtained as the second coupling part effectively will hook onto the offset in the coupling groove of the first coupling part upon coupling of the two devices by means of the hooks on the elastic fingers of the second disc.

When the free end faces of the hooks have an inclination facing obliquely outwards, the coupling can take place quickly and easily merely by pressing the coupling collars of the second coupling part into the coupling groove of the first coupling part. For the elastic fingers will thereby yield inwards so that the hooks can pass the projection on the radial exterior wall of the coupling groove and then subsequently resile so that the hooks will engage the offset of the projection. If the inside face facing the hooks in each window in the coupling collar of the first disc has a corresponding inclination as the free end faces of the hooks, and the two discs are placed at a distance from each other in the coupled state of the two devices, the uncoupling can be done easily merely by affecting the first disc with a small pressure with the fingers. Thereby, the first disc is displaced in relation to the other, whereby the above oblique inside face in each window will exert a pressure on oblique end faces of the hooks with a radially inwardly acting component which will press the hooks out of engagement with the offset in the coupling groove of the first coupling part so that the two coupling parts now can be separated from each other without difficulty.

In a second preferred embodiment according to the invention, the first and second coupling collar can quite simply be jammed or wedged together between the radial exterior and interior wall respectively of the first coupling part in the coupled state of the two devices. Thereby, an especially simple and inexpensive coupling is obtained that at the same time is quick and easy to operate.

To obtain an especially safe connection between the two coupling parts in the coupled state, the radial inside face of the first coupling collar can be conic with convergence in the direction opposite of the first disc. To further secure the connection between the two coupling parts, the free end of the first coupling collar can furthermore be designed with a relatively small hook facing radially outwards and engaging with the offset in the coupling groove in the coupled state of the two devices. If the radial exterior wall in the groove of the first coupling part is longer than the radial interior wall and the offset of the groove is located at a greater distance from its base than the free end face on its radial interior wall, it is advantageously obtained that the part of the first collar which is positioned above the offset will be affected to bend over the free inner edge of the offset and thereby be effectively clamped against this. The first disc can furthermore be designed with a guide collar defining a guide groove together with the first coupling collar, the guide groove will accommodate the radial exterior wall of the first coupling part in mounted state. Thereby, the first coupling part can safely and easily be guided correctly in place on the first disc at mounting.

The two discs of the second coupling part can furthermore be pivotally connected by means of a hinge for ensuring the correct, mutual position of the two discs. The hinge can be of any suitable kind but in a preferred embodiment, it consists of two pins facing in opposite directions and placed on each their bracket on the second disc, two slots pointing inwards, originating from the periphery of the first disc and serving for accommodating the brackets, two elevations inclining outwards on the first disc, and two bearing bushes designed in each their elevation for journaling of the pins. The two discs can be joined by pushing the brackets of the first disc into the slots of the second disc whereby the pins of the first disc elastically will slide up over the elevations of the second disc and then spring down into the bearing bushes of the elevations.

The first disc can advantageously have a greater diameter than the second disc and can preferably rest against this second disc when the two coupling parts are coupled to each other. Then, uncoupling takes place by pressing lightly against mainly diametrically opposite, peripheral areas on the first disc with the fingers, the first disc will thereby be deformed so that the second coupling part can be opened and the coupling be released.

The first disc which has to be easily deformable can especially be made of a relatively flexible material whereas the second disc which is not wanted deformed to the same extent simultaneously is made of a relatively more rigid material and furthermore is reinforced by at least one circumferential reinforcing rib. If the first disc is made of a transparent material, it will be possible visually to observe the subjacent second disc and thereby be able to safely operate the coupling.

The invention also relates to a method for using the coupling described above whereby the two discs of the second coupling part are joined, the second coupling part is arranged inside a pouch so that the inside face of an area around the aperture of the pouch is joined with and fastened to the first disc with the coupling collars extending out through the aperture in the pouch. If the two coupling collars of the second coupling part are inserted in the coupling groove of the first coupling part, the first and second coupling part can be joined easily and quickly. Upon manipulating the first disc, the engagement between the two coupling parts can be released quickly.

If the method is used for preparing an ostomy pouch, a stomy-operated person can now change the ostomy pouch quickly, easily and hygienically when needed. During this, the mainly disc-shaped discs of the second coupling part will give the person an easily locatable and convenient support to the person's fingers during the manipulation of the second coupling part. The operations of coupling and uncoupling respectively the two coupling parts can be done by means of little finger strength.

Where the coupling collars of the second coupling part is of the kind that function by means of fingers with hooks on the second disc in windows on the first disc, the two coupling collars can easily be inserted jointly in the coupling groove of the first coupling part upon joining, whereby the hooks of the fingers immediately will engage with the offset in the coupling groove so that the two coupling parts are locked together in a detachable manner.

The uncoupling quite simply takes place merely by displacing the first disc distally. Thereby, its windows are also displaced distally, whereby their obliquely inclining inside face abutting against the corresponding oblique top face on the hooks will press these hooks out of their engagement with the offset so that the coupling can be released.

If the coupling collars of the second coupling part are of the kind that function by getting pressed together in the coupling groove of the first coupling part, the coupling can take place easily and effortlessly by first placing the radial exterior wall of the first coupling part in the guide groove of the first disc while the two hinged discs are forming an angle in relation to each other and then swinging the second coupling collar into the coupling groove so that both coupling collars are effectively wedged in the coupling groove.

The engagement between the two coupling parts is released by, with the fingers, affecting the first disc with mainly diametrically opposite compressive forces in peripheral areas whereby the first disc is deformed in such a way that its coupling collar is bent and thereby releases the engagement with the coupling groove of the first coupling part at the same time as the peripheral areas on the first disc will force the second disc to swing out of the engagement of its coupling collar with the coupling groove.

Below, the invention is described on the assumption that the coupling is used for coupling an ostomy pouch to an implant implanted around a stoma of a stomy-operated person. The invention is not limited to this specific application but can be used for coupling many other devices with just as great advantages.

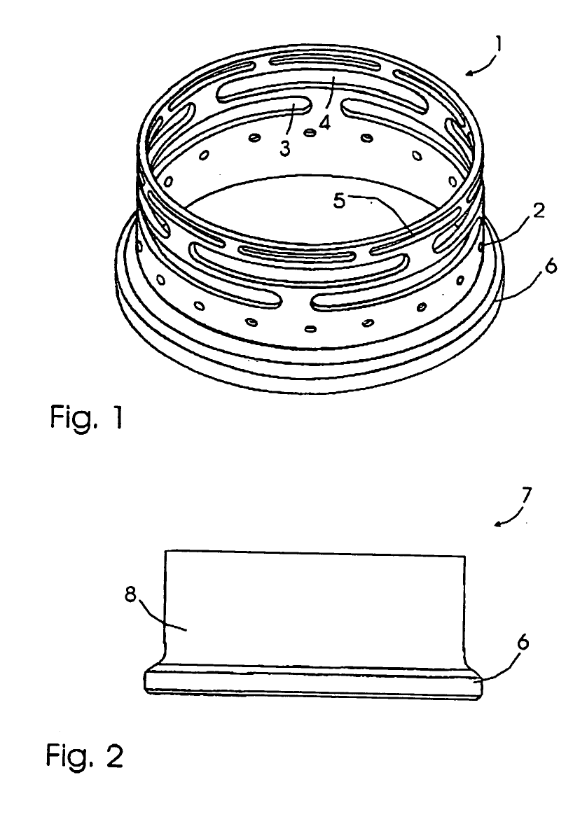

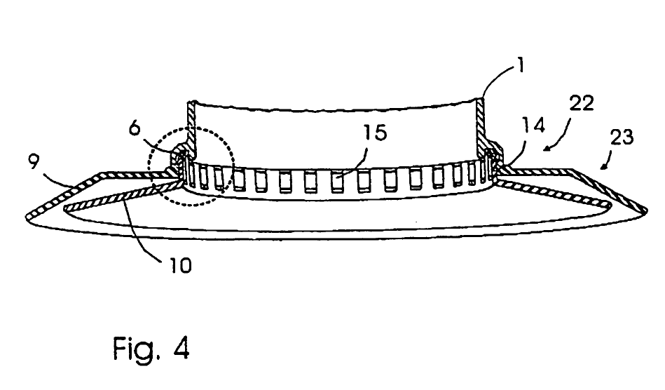

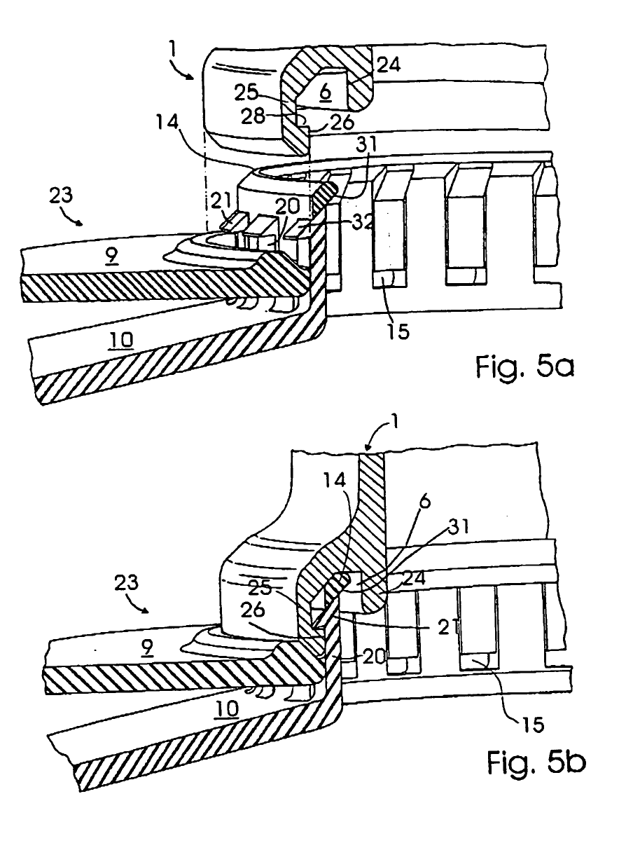

FIG. 1 is a perspective view of a first coupling part 1 in form of an annular implant 1. The implant 1 is designed with a number of circumferential, uniformly distributed suture apertures 2, a number of circumferential, uniformly distributed first transverse through apertures 3,4, and a number of circumferential, uniformly distributed third transverse through apertures 5. At the opposite end, the implant 1 has a circumferential coupling groove 6 which is not shown in FIG. 1 but will be mentioned in detail with reference to FIG. 4 and FIGS. 5a,b.

Upon surgical implantation, the implant 1 is positioned in such a way that the coupling groove 6 is extending at least a distance from the body. The implant is sutured in or to the skin by means of sutures through the suture apertures 2. The growth of tissue in through the transverse apertures 3,4 and possibly also through the transverse apertures 5 ensures a strong, blood-supplied anchoring of the implant.

If desired, the implant can be additionally anchored by means of anchoring means, not shown, in form of e.g. porous, flexible, elongated, biocompatible textile meshes fastened in the transverse apertures 5. The above implantation of the implant 1 is not shown in the drawing. Also, the method described in the patent application WO 01/08597 can advantageously be used for implantation of the implant 1 described above.

The textile meshes described in this patent a reflexible and can be directed in any fastening direction. Furthermore, their length can be adjusted to the individual anatomic proportions, and their pliability and flexibility make it possible to fasten and anchor the implant in e.g. different angles and more or less deep-lying muscularis or fascia.

FIG. 2 shows a simple embodiment of a first coupling part 7. This implant consists of a cylindrical, tubular branch piece 8 designed with the coupling groove 6 mentioned above at a free end. The branch piece 8 in FIG. 2 has a cylindrical shape and a smooth surface. For e.g. mounting on a tube (not shown), the branch piece 8 can alternatively and advantageously be conically designed instead of cylindrical and be provided with a thread or barbs instead of a smooth surface. Therefore, the branch piece 8 can be designed in dependence on the purpose of the coupling.

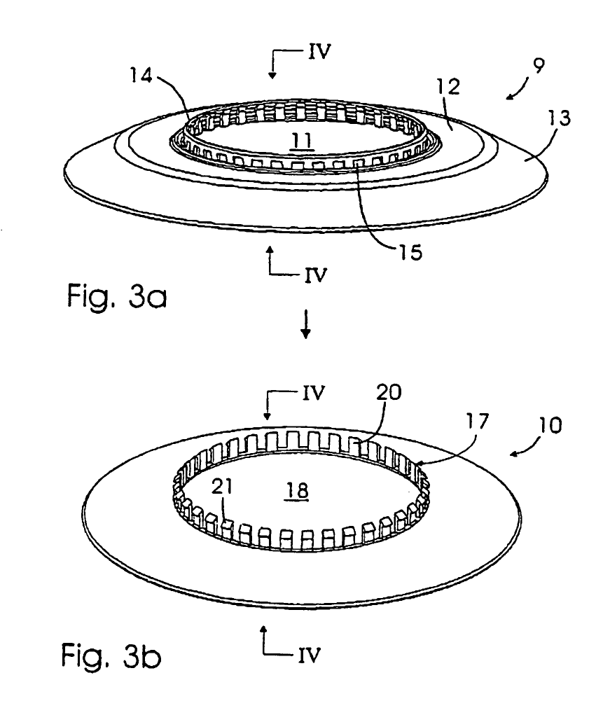

FIGS. 3-7 show a first embodiment of the coupling according to the invention. The second coupling part is made up of the mainly annular first disc 9 in FIG. 3a and the mainly annular second disc 10 in FIG. 3b. The two discs are designed with each their aperture, 11 and 18 respectively.

The first disc 9 has a first section 12 extending radially outwards from its aperture 11 in a direction mainly perpendicular to the axis of this aperture, and a conic second section 13 extending radially outwards in continuation of the first section 12 whereas the second disc 10 is extending conically outwards from its aperture 18.

Around the apertures 11,18 of the first and second disc, a first and second coupling collar respectively 14, 17 are designed extending mainly in cross direction of the respective disc. In the joined state of the second coupling part, the second coupling collar 17 is extending in through the aperture 11 in the first disc 9 in the same direction as the coupling collar 14 of this disc, as shown in FIGS. 4 and 5a,b.

The first coupling collar 14 is perforated by a number of uniformly distributed windows 15 whereas the second coupling collar 17 is divided by a number of elastic fingers 20 extending completely or partly into each their window 15.

The free end of each finger 20 is designed with a hook 21 facing radially outwards. The free end faces 32 of the hooks have an inclination extending obliquely outwards and forming an angle with the axis of the coupling of between 90° and 30°. A preferred angle is 45°.

The inside face 31 in each window 5 facing the hooks in the coupling collar 14 of the first disc 9 has a corresponding inclination. The two discs 9,10 are furthermore located at a distance from each other in the coupled state of the two devices.

Preferably, the first disc 9 has an external diameter which is larger than the external diameter of the second disc 10 so that the first disc 9 will accommodate the second disc 10 when the first disc 9 is joined with the second disc 10 by being guided towards this disc 10 in the direction indicated by the arrow in FIGS. 3a and 3b.

The joined coupling, now designated generally by the reference numeral 22, is shown in FIG. 4 showing an axial section of a fraction of a first coupling part 1 coupled to the second coupling part 23 which again is an assembly of the discs 9 and 10.

The coupling of the two coupling parts 1 and 23 and their specific arrangement is shown on a larger scale and in detail in the fraction of the coupling shown in perspective in FIGS. 5a and 5b.

The circumferential coupling groove 6 of the first coupling part 1 is defined by a radial interior wall 24 and a radial exterior wall 25 and is open in the direction facing the second coupling part. The radial exterior wall 25 of the coupling groove 6 is designed with a circumferential projection 26 facing radially inwards and defining an offset 28.

In FIG. 5a, the second coupling part 23, which is an assembly of the discs 9 and 10, is ready to be coupled to the first coupling part 1. As is shown, the fingers 20 of the disc 10 are extending into each their window 15 in the coupling collar 14 of the disc 9 with the hooks 21 extending a distance out of the respective window 15.

The coupling can now be done quickly and easily by quite simply pressing the first coupling collar 14 of the second coupling part 23 and its fingers 20 into the coupling groove 6 of the first coupling part by means of a modest pressure on the second coupling part 23 with the fingers. Thereby, the elastic fingers 20 will resile radially inwards in the windows 15 so that the hooks 21 are allowed to pass the projection 26 on the radial exterior wall 25 of the coupling groove 6 and subsequently resile back again so that the hooks 21 will engage with the offset 28 of the projection 26.

During the action of resiling back, the oblique end faces 32 of the hooks will slide along the oblique inside face 31 facing the hooks 21 in each window 15 in the coupling collar 14 of the first disc 9. Thereby, the spring power in the fingers will force the radial exterior wall 25 of the first coupling part into close abutment against an area of the first disc in the coupled state of the two devices.

In FIG. 5b, the coupling has been completed. The two coupling parts are now coupled closely and safely to each other so that the stomy-operated person is effectively ensured against the coupling unfastening and against unhygienic leakage of secretions or excretions taking place from the stoma.

When the ostomy pouch (not shown in FIGS. 1-6) has been filled to a desired extent, it often has to be removed to be replaced by a new pouch. The uncoupling can be done quickly and easily by, merely with a light pressure with the fingers on the first disc 9, displacing this disc distally in relation to the second disc 10 which continues to be hooked to the first coupling part 1 due to the engagement of the hooks 21 with the offset 28 of the coupling groove 6.

The displacement which is possible because the two discs 9 and 10, as mentioned earlier, are located at a mutual distance in coupled state causes the oblique inside faces 31 in each window 15 to exert a pressure with a radially inwards acting component against the oblique end faces 32 on the hooks 21 which thereby ultimately are pressed into the associated windows 15 and out of their engagement with the offset 28 in the coupling groove 6 of the first coupling part 1 whereby the engagement between the two coupling parts 1 and 23 is released.

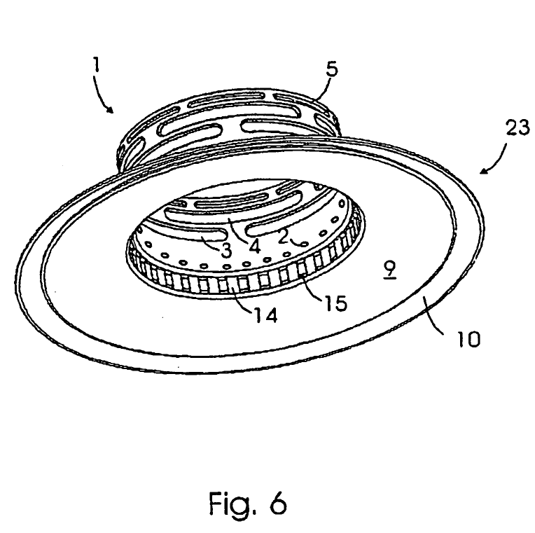

FIG. 6 is a perspective view obliquely from the bottom of The coupling according to the invention with the first coupling part 1 coupled to the second coupling part 23.

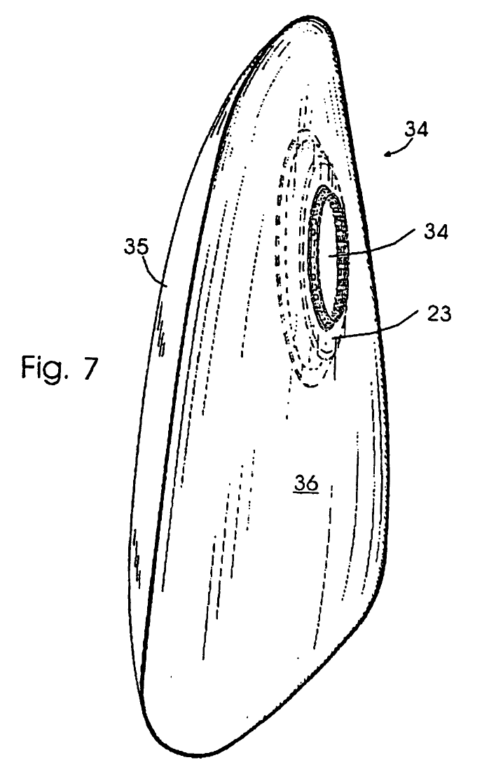

FIG. 7 is a perspective view of the second coupling part 23 placed inside an ostomy pouch 34 having a distal exterior wall 35 and a distal interior wall 36 with an aperture 37. The inside of an edge section of the distal interior wall 36 along the aperture 37 of the ostomy pouch 34 is closely joined with the outer side of the radial first section 12 of the first disc 9. The manipulation of the first disc with the fingers at coupling and uncoupling respectively thus takes place via the relatively thin, flexible interior wall of the ostomy pouch.

As can be seen, the first coupling collar 14 and fingers 20 of the second coupling part 23 are extending a short distance out of the aperture 37 whereby the coupling groove 6 on the first coupling part 1 easily can engage with the second coupling part 23.

In the drawings, it is shown that the number of windows in the second coupling part corresponds to the number of fingers. However, the invention is not limited to this, as the number of windows also can be greater than the number of fingers within the scope of the invention.

The coupling parts can advantageously be injection-molded of a relatively rigid plastic, which furthermore has the flexibility and elasticity necessary for the fingers on the second coupling part.

A bendable and/or flexible biocompatible, synthetic or biosynthetic polymer is preferred especially for ostomy pouches.

An implant which preferably must be rigid can be made of titanium or possibly a titanium alloy but where the first coupling part is to be used for other purposes than the previously mentioned, this part can be made of any kind of expedient material such as copper or stainless steel.

If the first coupling part is permanently mounted as for example is the case with an implant, this coupling part is typically made of a very durable material able to resist for example acid exposure and other kinds of chemical or mechanical actions whereas the second coupling part at the same time typically is used for a disposable article which is to be discarded after use one or a few times. In this case, the second coupling part can be made of a relatively inexpensive material, for example plastic.

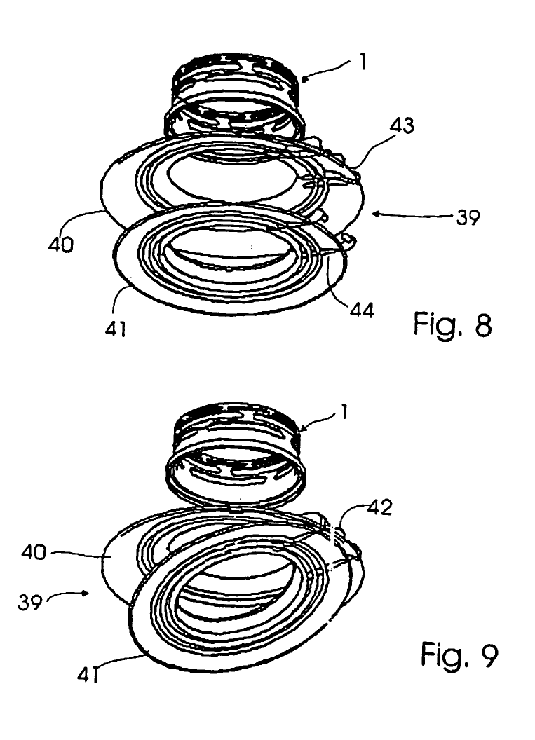

FIGS. 8-16 show a second embodiment of The coupling according to the invention with a first coupling part 38 and a second coupling part 39. In this case, the first coupling part 38 is designed mainly in the same way as the implant 1 in FIGS. 1, 4, 5a,b, and 6 and can correspondingly be used to enclose the stoma of a stomy-operated person. Therefore, same reference numerals are also used in this case.

The second coupling part consists of a first annular disc 40 and a second annular disc 41. The two discs are hinged to each other by means of a hinge 42 consisting of a first hinge part 43 on the first disc 40 and a second hinge part 44 on the second disc 41. This hinge will be described later in detail.

FIG. 8 is an exploded perspective view of the coupling. In FIG. 9, the two discs 40,41 of the second coupling part 39 are hinged to each other by means of the hinge 42. The second coupling part is in an opened position in which the two discs form an angle with each other.

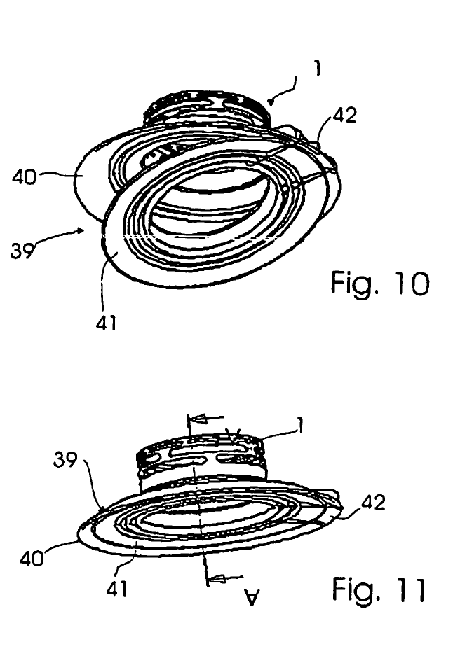

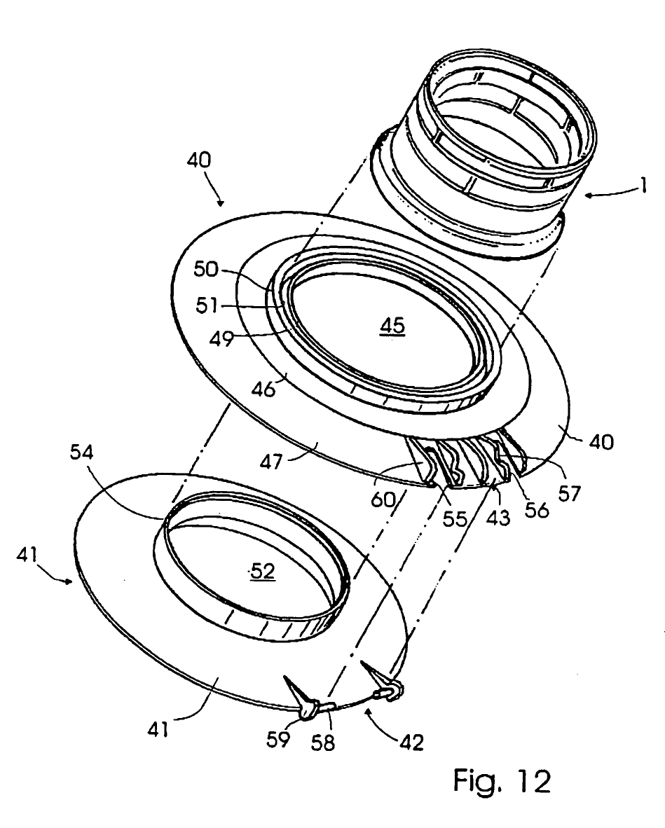

In FIG. 10, the implant 1 is detachably joined with the first disc 40, and in FIG. 11, the second coupling part has been closed by the second disc 41 being turned in under the first disc about the hinge 42. Thereby, the implant is locked in the second coupling part 39 in the way described below with reference to FIGS. 12-16.

As seen best in FIGS. 12-16, the first disc of the second coupling part 39 has an aperture 45. A first section 46 is extending radially outwards from this aperture 45 in a direction mainly perpendicularly to the axis of the aperture whereas a conic second section 47 is extending radially outwards in continuation of the first section 46.

Under the first section 46 of the disc are two reinforcing ribs 48 for stabilizing the area on the first disc to which an ostomy pouch (not shown in FIGS. 12-14) preferably is fastened.

A first coupling collar 49 is designed around the aperture 45 on the first section 46 of the first disc 40, and a guide collar 50 is designed at a radial distance from this coupling collar. The two collars 40,50 define a circumferential guide groove 51.

The second disc 41 of the second coupling part 39 has an aperture 52 and is extending conically outwards from this aperture. Under the disc 41 are three reinforcing ribs 53. A second coupling collar 54 is furthermore designed around the aperture 52.

As seen best in FIG. 12, the first hinge part 43 on the first disc 40 consists of two slots 55 issuing from the periphery of the disc and two elevations 56 inclining outwards and each elevation forming a bearing bush 57. The second hinge part 44 on the second disc 41 consists of two pins 58 facing in opposite directions on each their bracket 59 fitting in spacing and dimension to be inserted in the slots 55.

On hinging the two discs 40,41 together, the brackets 59 of the second disc 41 are pushed into the slots 55 whereby the pins 58 are forced up over the inclined elevations 56 to finally jump down into these bearing 57.

The hinge 42 has now been formed, the pins 58 being held rotatably in the bearing bushes 57 by the subjacent, peripheral section of the second disc 41, the section simultaneously serving for limiting the possible mutual pivoting of the two discs 40,41 to a pre-determined angle of opening.

The area on the first disc 40 at the first hinge part 43 is reinforced by reinforcing ribs 60.

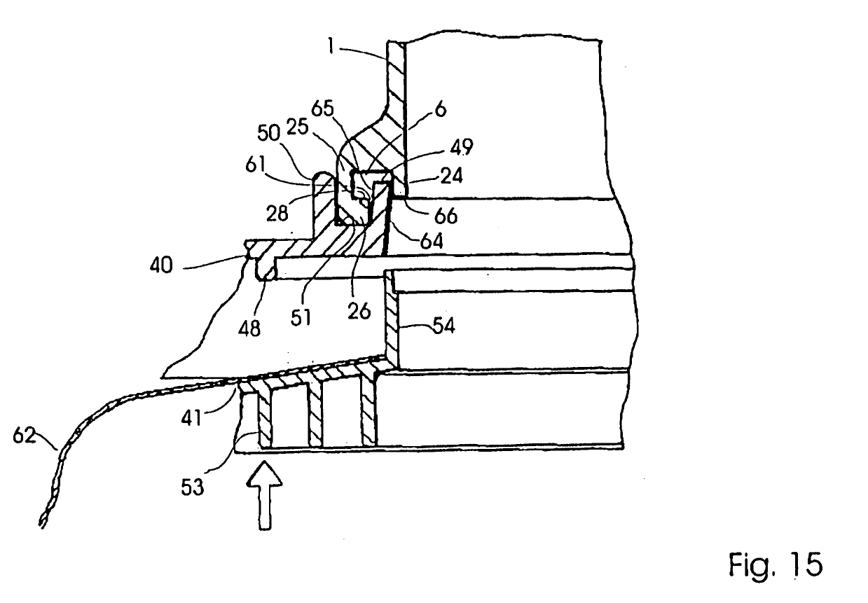

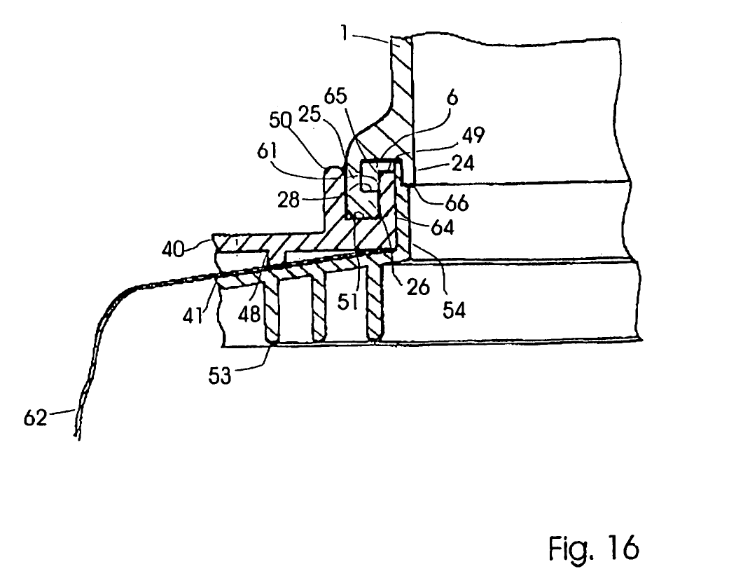

FIGS. 15 and 16 are on a larger scale sectional fractional views of the coupling according to the invention with an ostomy pouch 62 only shown fractionally attached on the first section 46 of the first disc 40.

Also in this case, the implant 1 has a circumferential coupling groove 6 defined by a radial interior wall 24 and a radial exterior wall 25 and is open in the direction facing the second coupling part 38. The radial exterior wall 25 of the coupling groove 6 is designed with a circumferential projection 26 facing radially inwards and defining an offset 28 with a top edge 61.

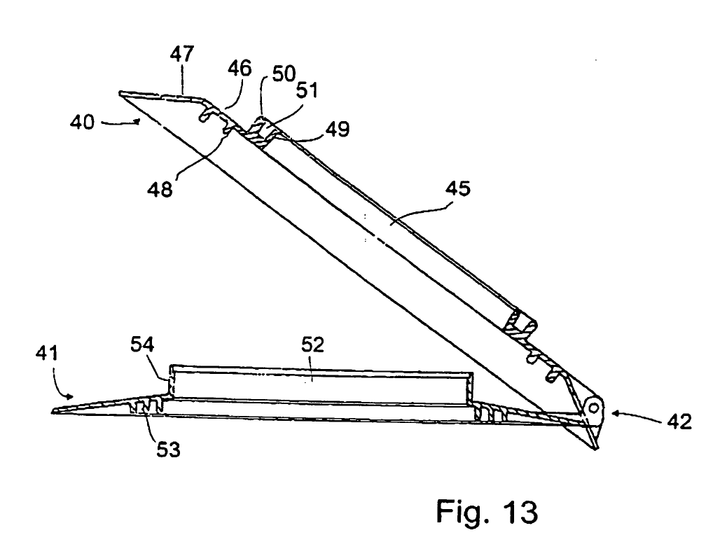

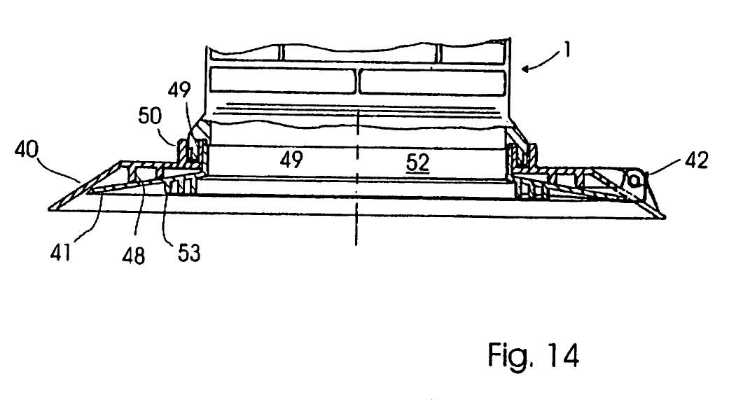

The hinge 42 of the second coupling part 39, which cannot be seen in the fractional view of the coupling, is located in the right side of the drawing. In FIG. 15, the second coupling part is being closed. In FIG. 16, it has been completely closed. See also FIGS. 13 and 14.

In the case shown, the radial inside face 64 of the first coupling collar 49 is conic converging towards the implant 1. Its radial outer side 65 is congruent with the inside face 64. Furthermore, the edge 61 of the offset 28 is located at a greater distal distance than the free end face 66 of the interior wall 24.

Coupling of the first and second coupling part 38,39 now takes place in the following way.

The second coupling part 39 is opened, as shown for example in FIG. 13, and in this state guided towards the implant I so that the radial exterior wall 25 of its coupling groove 6 will be located in the guide groove 51 of the first disc 40 between the coupling collar 49 and the guide collar 50 both extending out of the aperture 63 of the ostomy pouch 62.

Then, the second coupling part 39 is closed, as indicated by the arrow in FIG. 15, by swinging the second disc 41 in towards the first disc 40.

In FIG. 16, the second coupling part has now been completely closed whereby the coupling collar 54 of the second disc 41 has been wedged in between the radial interior wall 24 of the coupling groove 6 and the coupling collar 49 of the first disc 40, the bottom part of which collar is thereby pressed in against the radially inwardly facing projection 26 of the coupling groove 6.

As the top edge 61 of the offset 28 is located at a greater distal distance than the free end face 66 of the interior wall 24, the upper part of the coupling collar 49 is furthermore affected to being bent in over the top edge 61 of the offset 28 whereby the coupling collar 49 of the first disc 40 is effectively locked to the projection 26 of the coupling groove 6 and thereby the ostomy pouch 62 with the implant 1.

To further secure the coupling between the two coupling parts 38,39, the upper part of the coupling collar 49 of the first disc 40 can be provided with a small circumferential hook (not shown) abutting against the top side of the projection 26 in the coupled state of the coupling.

It is noted that an effective coupling also can be obtained even if the top edge 61 of the offset 28 is located at a smaller distal distance than the free end face 66 of the interior wall 24, and if the radial outer side 65 of the coupling collar 49 is not congruent with its radial inside face 64.

The radial inside face 64 of the first coupling collar 49 does not have to be conic either. Instead, the coupling collar 54 of the second disc 41 can be conic and/or the outer side of the radial exterior wall 24 on the coupling groove 6 of the implant 1 can be conic.

Alternatively, none of the mentioned co-operating parts can be conic. The important thing is that the two coupling collars 49, 54 of the second coupling part 39 are effectively fastened in the coupling groove 6 of the implant 1 when its exterior wall 25 is in the guide groove 51 of the first disc 61 and the second coupling part is closed.

It is furthermore noted that there is no guide collar on the first disc of the second coupling part in an alternative embodiment. In this case, the implant is guided correctly in place on the first disc only by means of the coupling collar of this disc upon coupling.

In this embodiment the uncoupling takes place by pressing lightly against diametrically opposite peripheral areas on the first disc with the fingers whereby this disc is deformed in such a way that its coupling collar is bent and thereby releases the engagement with the coupling groove of the first coupling part at the same time as the peripheral areas on the first disc force the second disc to swing out of the engagement of its coupling collar with the coupling groove.

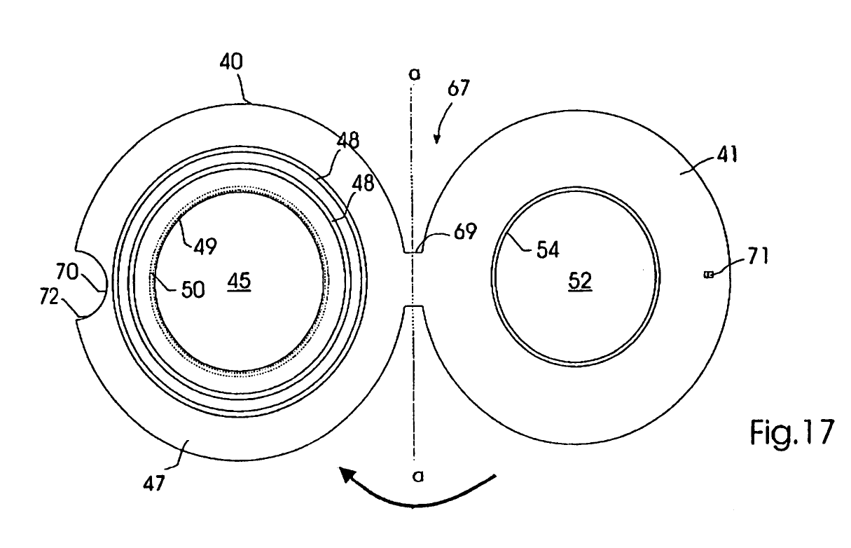

FIG. 17 shows a blank 67 for a third embodiment for a second coupling part 68 for The coupling according to the invention. The first disc 40 and second disc 41 is interconnected by means of an integral hinge 69. The first disc 40 has a cut-out section 70 for co-operating with a clip or a hook 71 on the second disc 41.

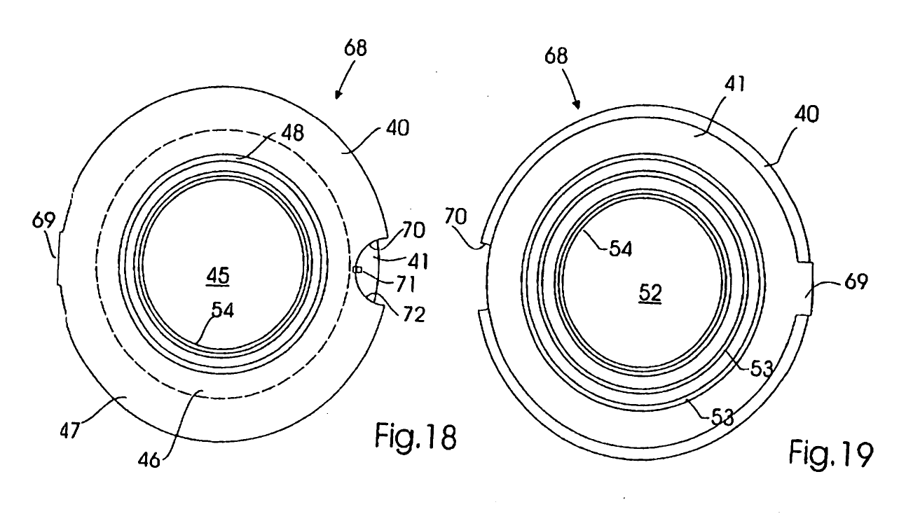

When the second coupling part 68 is set up for use the second disc 41 is folded in over the first disc 40 along the line a-a thereby forming the integral hinge 69 so that the clip 71 engage the edge 72 of the cut-out section 70 for locking the two discs 40,41 together and holding the discs together in a closed condition during use as seen best in FIG. 18 and 19.

Preferably the blank 67 is molded or cast in one piece by means of the commonly known polymer forming techniques within the art, including compression molding, transfer molding and injection molding. By manufacturing the entire second coupling as one single blank, the coupling can be manufactured in a very inexpensive way.

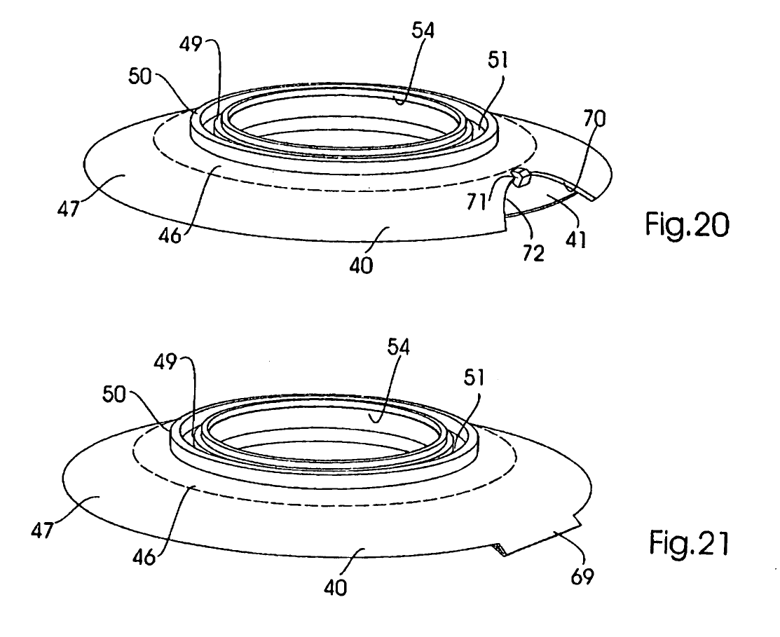

From FIGS. 18, 19 and 20 it is seen that cut-out section 70 allows free access for a persons finger (not shown) to manipulate the clip 71 for disengaging the locking relationship between the two discs 40,41.

FIG. 21 shows a perspective view of the closed third embodiment 68 of the second coupling. The folded integral hinge 69 pivotably joins the first disc 40 and the second disc 41 and is for illustration purposes shown protruding a distance from the discs 40,41. However, it is preferred that the hinge 69 does not or only slightly protrude from the periphery of the disc 40 having the largest diameter.

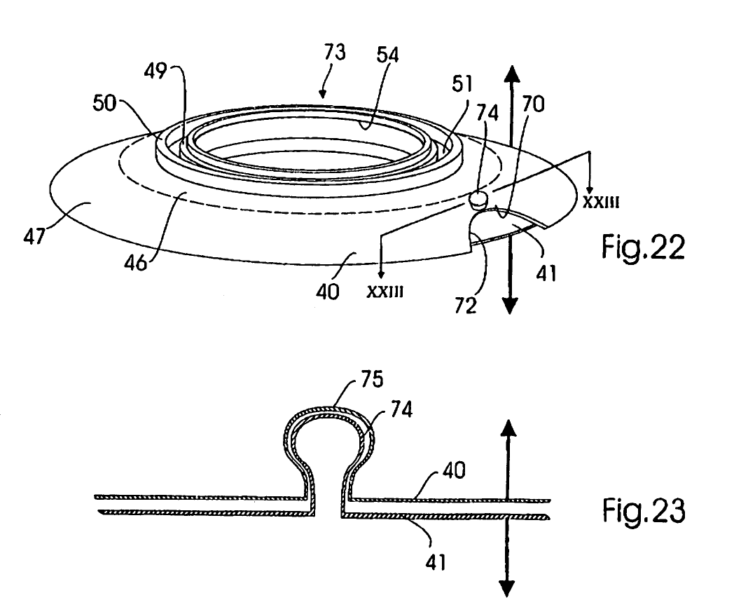

FIG. 22 shows a perspective view of a fourth embodiment 73 of the second coupling. In this embodiment the lock means between the first disc 40 and the second disc 41 is a bead 74 made on the second disc 41 for engaging with a dimple 75 made on the first disc 40. For disengaging the bead 74 from the dimple 75 the two discs 40,41 are forced pivotably away from each other using the fingers for pressing the discs in opposite directions as indicated by the arrows.

The fractional sectional view of FIG. 22 taken along the line XXIII-XXIII shows on a larger scale in FIG. 23 the mushroom-shaped bead 74 accommodated in the dimple 75.

It applies for all embodiment of the second coupling that upon terminating the locking relationship between the two discs an already mounted first coupling will be set free.

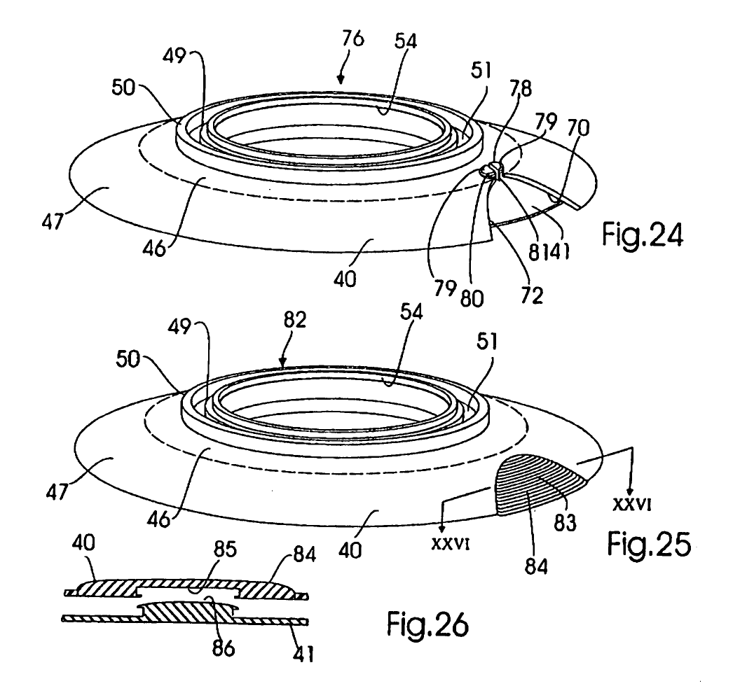

FIG. 24 shows a perspective view of a fifth embodiment of the second coupling seen from a third embodiment for a lock means,

FIG. 25 shows a perspective view of a sixth embodiment of the second coupling seen from a fourth embodiment for a lock means, and

FIG. 26 shows on a larger scale a fractional sectional view of the fourth embodiment for the lock means taken along the line XXVI-XXVI of FIG. 25.

The first disc can preferably be made of a relatively flexible material which is easily deformed whereas the second disc preferably is made of a relatively more rigid material.

To easily be able to release the coupling between the two coupling parts in the above-mentioned way, the first disc 40 is preferably greater than the subjacent second disc 41 which thereby is covered by the first disc 40.

Therefore, the first disc can advantageously be made of a transparent material whereby it is possible visually to observe the subjacent second disc and thereby be able to safely follow the functioning of the coupling during coupling and uncoupling respectively.

As it appears from the above description of two embodiments of The coupling for connecting an ostomy pouch with the stoma of a stomy-operated person, an effective means has now been provided by means of the invention, that in a better way than hitherto known enables a person to quickly, easily, conveniently and hygienically change an ostomy pouch when needed by means of only quite modest finger strength.

But the description is not envisaged to limit the invention to couplings for an stomy-operated person as variations and modifications of the above teaching based on the knowledge of a person skilled in the prior art also is comprised within the scope of the invention.

Thus, the invention can advantageously be used for many other purposes than the detachable coupling between a stoma of a stomy-operated person and an ostomy pouch described above and in the shown drawing. For example, the invention can advantageously also be used for coupling of pneumatic and hydraulic devices.

The invention is to be construed on the basis of the accompanying claims, and the described embodiments are preferred ways of carrying out the invention. Therefore, the coupling collars also comprises alternative embodiments modified and changed within the scope of the prior art.

What is claimed is:

1. A coupling for detachably coupling first and second devices comprising:
a first coupling part on the first device and a second coupling part on the second device, with the first coupling part having a circumferential coupling groove defined by a radial interior and exterior walls respectively and ending in a free end face facing in the opposite direction of the first device, and the second coupling part including first and second discs each having an aperture, and
first and second coupling collars respectively designed around the apertures of the first and second discs and extending mainly in a cross direction of each respective disc,
wherein the second coupling collar extends through the aperture of the first disc in the same direction as the coupling collar of this disc, and the two coupling collars of the second coupling part extend into and engage the circumferential coupling groove of the first coupling part when the devices are coupled.

2. The coupling according to claim 1, wherein the radial exterior wall of the coupling groove includes a circumferential projection facing radially inwards and defining an offset.

3. The coupling according to claim 1, wherein the free end face of the radial exterior wall of the coupling groove abuts closely against the first disc when the devices are coupled.

4. The coupling according to claim 1, wherein the radial exterior wall of the coupling groove is longer than its radial interior wall when viewed in cross section.

5. The coupling according to claim 1, wherein the first coupling collar is perforated by a number of uniformly distributed windows, the second coupling collar is divided into a number of elastic fingers that completely or partly extend into or through each window, the free end of each finger is designed with a hook facing radially outwards, and the hooks abut against an offset on the radial exterior wall in the coupling groove of the first coupling part when the devices are coupled.

6. The coupling according to claim 5, wherein free end faces of the hooks have an inclination facing obliquely outwards, the inside face of each window of the coupling collar of the first disc facing the hooks has a corresponding inclination, and that the two discs are located at a distance from each other when the devices are coupled.

7. The coupling according to claim 1, wherein the first and second coupling collars are arranged to be pressed together between the radial interior wall and exterior wall respectively of the first coupling part when the devices are coupled.

8. The coupling according to claim 7, wherein the radial inside face of the first coupling collar is conic converging in the direction opposite the first disc.

9. The coupling according to claim 7, wherein the free end of the first coupling collar is designed with a hook facing radially outwards and engaging with an offset of the coupling groove when the devices are coupled.

10. The coupling according to claim 9, wherein the offset of the coupling groove is located at a greater distal distance than the free end face on its radial interior wall.

11. The coupling according to claim 7, wherein the two discs are pivotally connected to each other by a hinge.

12. The coupling according to claim 11, wherein the hinge comprises at least two pins facing in opposite directions and placed on each their bracket on the second disc, at least two slots pointing inwards and issuing from the periphery of the first disc and serving for accommodating the brackets, at least two elevations inclining outwards on the first disc, and bearing bushes for journaling of the pins.

13. The coupling according to claim 1 1, wherein the hinge is an integral hinge.

14. The coupling according to claim 7, wherein the first disc is designed with a guide collar, with the guide collar together with the first coupling collar defining a guide groove which accommodates the radial exterior wall of the first coupling part when the devices are coupled.

15. The coupling according to claim 7, wherein the first disc has a greater diameter than the second disc.

16. The coupling according to claim 7, wherein the first disc is made of a relatively flexible material whereas the second disc is made of a more rigid material.

17. The coupling according to claim 7, wherein at least the second disc is reinforced with at least one circumferential reinforcing rib.

18. The coupling according to claim 7, wherein the first disc is made of a transparent material.

19. The coupling according to claim 1, which further comprises locking means for locking the first and the second discs together when the devices are coupled and the coupling is arranged substantially diametrically opposite the hinge of the second coupling part.

20. The coupling according to claim 19, wherein the locking means comprises a cut-out section in the first disc and a clip or a hook mounted on the second disc to clip around at least a part of the edge of the cut-out section of the first disc for locking the discs together when the devices are coupled.

21. The coupling according to claim 19, wherein the locking means comprises a cut-out section in the first disc, a dimple arranged substantially in the area along the edge of the cut-out section and a bead on the second disc for locking engagement with the dimple when the devices are coupled.

22. The coupling according to claim 19, wherein the locking means comprises a grasping section on the first disc, the grasping section having a recess facing the second disc and the second disc having a tongue for engaging the recess when mounted.

23. The coupling according to claim 22, wherein the grasping section has a corrugated surface.

24. The coupling according to claim 1, wherein the first disc has a first section extending radially outwards from its aperture in a direction mainly perpendicular to its axis, and a conic second section extending radially outwards in continuation of the first section.

25. The coupling according to claim 1, wherein the second disc extends conically outwards from its aperture.

26. The coupling according to claim 1, wherein the first coupling part is an implant for implantation around a stoma of an animal or human body.

27. The coupling according to claim 1, wherein the second coupling part is placed inside a pouch for coupling with the implant with the coupling collars extending out through an aperture in the pouch.

28. The coupling according to claim 27, wherein an inside of an edge section along the aperture of the pouch is closely joined with the outer side of the radial first section of the first disc.

29. A method for application of a coupling according to claim 1, wherein the two discs of the second coupling part are joined, the second coupling part is placed inside a pouch, and the inside of an area around an aperture of the pouch is joined with and fastened to the first disc with the coupling collars extending out through the aperture of the pouch.

30. The method according to claim 29, wherein the two coupling collars of the second coupling part together are pushed into the coupling groove of the first coupling part.

31. The method according to claim 29, wherein the radial exterior wall of the first coupling part forming the radial outer definition of the coupling groove is placed in the guide groove in the first disc of the second coupling part while the second coupling part is open, and the second coupling part then is closed.

32. The method according to claim 29, which further comprises uncoupling the parts by releasing the engagement between the two coupling parts by manipulation of the first disc.

33. The method according to claim 32, wherein the engagement between the two coupling parts is released by distally displacing the first disc.

34. The method according to claim 32, wherein the engagement between the two coupling parts is released by affecting the first disc with radially opposite compressive forces in peripheral areas.

35. An ostomy pouch obtained by the method according to claim 29.

36. A method for application of the coupling according to claim 1 and an ostomy pouch, wherein the first coupling part in the form of an annular implant having a projecting section with the coupling groove is implanted around a stoma, and an ostomy pouch is coupled to the implant by the two coupling collars of the second coupling part being pushed into the coupling groove of the first coupling part.

37. The method according to claim 36, wherein the engagement between the two coupling parts is released by manipulation of the first disc.

38. The method according to claim 36, wherein the engagement between the two coupling parts is released by manipulation of the locking means for disengaging the lock between the first and the second disc.
